(19) United States
(12) Patent Application Publication
(10) Pub. No.: US 2025/0078151 A1
(43) Pub. Date: Mar. 6, 2025

(54) SYSTEMS AND METHODS USING LARGE LANGUAGE MODEL-BASED VIRTUAL ASSISTANTS AND TASK LIBRARIES

(71) Applicant: TidalWave Tech Inc., New York, NY (US)

(72) Inventors: Jiuqing Deng, Kirkland, WA (US); Mai Hou, Jersey City, NJ (US); Cheng Li, New York, NY (US); Diane Yu, New York, NY (US)

(73) Assignee: TidalWave Tech Inc., New York, NY (US)

(21) Appl. No.: 18/823,881

(22) Filed: Sep. 4, 2024

Related U.S. Application Data
(63) Continuation-in-part of application No. 18/242,415, filed on Sep. 5, 2023.

(51) Int. Cl. G06Q 40/03; G06F 9/451

(52) U.S. Cl. CPC G06Q 40/03; G06F 9/453

(57) ABSTRACT

Described herein are systems and methods that take advantage of a self-servicing mortgage engine that utilizes a language-model-based virtual assistant with access to knowledge databases, loan product databases, and underwriting databases. The mortgage engine integrates rules-based responses with the language model to analyze user input from conversations and provide context-aware interactive guidance, e.g., in the form of easy-to-understand explanations, instructions, and suggestions tailored to user questions. The interactive guidance generates recommendations and actionable outputs for borrowers that reduce the complexities of the lending process and drives the loan application. Advantageously, this increase efficiency and transparency for the borrower, while simultaneously reducing costs to lenders.

### CROSS REFERENCE TO RELATED PATENT APPLICATIONS

The present application is a continuation-in-part application of U.S. patent application Ser. No. 18/242,415, entitled “LOAN ORIGINATION SYSTEMS AND METHODS USING LARGE LANGUAGE MODEL (LLM)-BASED VIRTUAL ASSISTANTS AND TASK LIBRARIES” naming as inventors Jiuqing Deng, Mai Hou, Cheng Li, and Diane Yu, filed on Sep. 5, 2023, which application is hereby incorporated herein by reference in their entirety.

### BACKGROUND

### A. Technical Field

The present disclosure relates generally to systems and methods for financial transactions such as loan product processing. More particularly, the present disclosure relates to systems and methods for improving the ease of providing and obtaining loan products through advanced automation processes.

### B. Background

Conventional loan origination is a complex and cumbersome process that oftentimes overwhelms borrowers with new concepts and specific terminology. Traditional loan application procedures involve multiple stages, such as educating the borrower, gathering necessary information and documents, explaining and discussing loan details, choosing a suitable loan product, verifying financial data (including credit history, liabilities, employment, income, and assets), and addressing issues that arise, exploring various services like title searches and appraisals. These tasks involve interactions with various stakeholders such as loan officers, processors, and closers.

Such activities span across diverse systems, interfaces, and human agents, demanding substantial commitments from both borrowers and lenders. Consequently, this process is time-consuming, resource-intensive, and may introduce unnecessary friction into the process. In essence, the path to loan qualification and product selection, complicated by numerous loan options laden with challenging jargon, forces an ordinary borrower to navigate a prolonged and often confusing application and approval process. Despite the assistance of an informed loan officer, the experience remains burdensome and unsatisfactory for the typical borrower.

Therefore, there is a need for improved loan processing systems and methods that allow borrowers to follow easy-to-understand instructions and obtain relevant information that can guide users through the process and, ideally, deliver user-specific recommendations in a user-friendly fashion that enhances user experience.

To accomplish this, embodiments described herein utilize an interactive virtual assistant that combines rules-based responses with a language model to analyze user input and provide context-aware guidance in the form of user-friendly answers and explanations, tailored to address user questions to generate personalized recommendations. Advantageously, this enables convenient and efficient tools that successfully steer users through a transparent and personalized loan process that facilitates self-guided navigation and allows users to arrive at informed decisions without the need for time-intensive research. In addition, by applying standardized rules to all individuals, and eliminating the variability of personal judgment or subjective experience often tied to loan officers, embodiments herein contribute to a more consistent loan processing journey. Advantageously, this standardization helps mitigate bias that, otherwise, may arise from disparate treatment of loan applicants by different loan officers.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments. Items in the figures are not to scale.

FIG. 1 is a general illustration of a context-aware loan origination system according to various embodiments of the present disclosure.

FIG. 2 is a flowchart of an illustrative process for using the system shown in FIG. 1 according to various embodiments of the present disclosure.

FIG. 3 illustrates a virtual assistant that increases the accuracy of answers, according to various embodiments of the present disclosure.

FIG. 4 is a flowchart of an illustrative process for increasing the accuracy of answers, according to various embodiments of the present disclosure.

FIG. 5 illustrates a virtual assistant that aligns or calibrates questions and answers to generate explanatory text regarding calculations, according to various embodiments of the present disclosure.

FIG. 6 is a flowchart of an illustrative process for explaining a calculation, according to various embodiments of the present disclosure.

FIG. 7 illustrates a virtual assistant that aligns or calibrates questions and answers to generate user-specific answers and/or product recommendations based on interactions at a chat interface or task interface, according to various embodiments of the present disclosure.

FIG. 8 is a flowchart of an illustrative process for generating user-specific answers and/or product recommendations based on interactions at a chat interface or task interface, according to various embodiments of the present disclosure.

FIG. 9 illustrates a virtual assistant that generates actionable outputs based on configurable loan specification, according to various embodiments of the present disclosure.

FIG. 10 is a flowchart of an illustrative process for actionable outputs based on configurable loan specification, according to various embodiments of the present disclosure.

FIG. 11 is a flowchart illustrating a process for using an AUS, according to various embodiments of the present disclosure.

FIG. 12 is a flowchart illustrating a process for managing user interactions and tool execution, according to various embodiments of the present disclosure.

FIG. 13 illustrates a system for performing the processes in FIG. 11 and/or FIG. 12 to manage a loan origination process, according to various embodiments of the present disclosure.

FIG. 14 depicts a simplified block diagram of a computing device/information handling system, in accordance with embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, a person skilled in the art will recognize that embodiments of the present disclosure, described below, may be implemented in a variety of ways, such as a process, an apparatus, a system/device, or a method on a tangible computer-readable medium.

Components, or modules, shown in diagrams are illustrative of exemplary embodiments of the disclosure and are meant to avoid obscuring the disclosure. It shall be understood that throughout this discussion components may be described as separate functional units, which may comprise sub-units, but those skilled in the art will recognize that various components, or portions thereof, may be divided into separate components or may be integrated, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgment, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification do not necessarily all refer to the same embodiment or embodiments.

The use of certain terms in various places in the specification is for illustration and should not be construed as limiting. The terms “include,” “including,” “comprise,” “comprising,” and any of their variants shall be understood to be open terms, and any examples or lists of items are provided by way of illustration and shall not be used to limit the scope of this disclosure.

Any headings used herein are for organizational purposes only and shall not be used to limit the scope of the description or the claims. Each reference/document mentioned in this patent document is incorporated by reference herein in its entirety.

Furthermore, it shall be noted that embodiments described herein are framed in the context of loan applications, but one skilled in the art shall recognize that the concepts of the present disclosure are not limited to loan applications and may equally be used in other financial and non-financial contexts.

In this document, the terms “virtual assistant” and “chatbot” are used interchangeably. Similarly, the terms “loan officer,” “mortgage officer,” and broker are used interchangeably

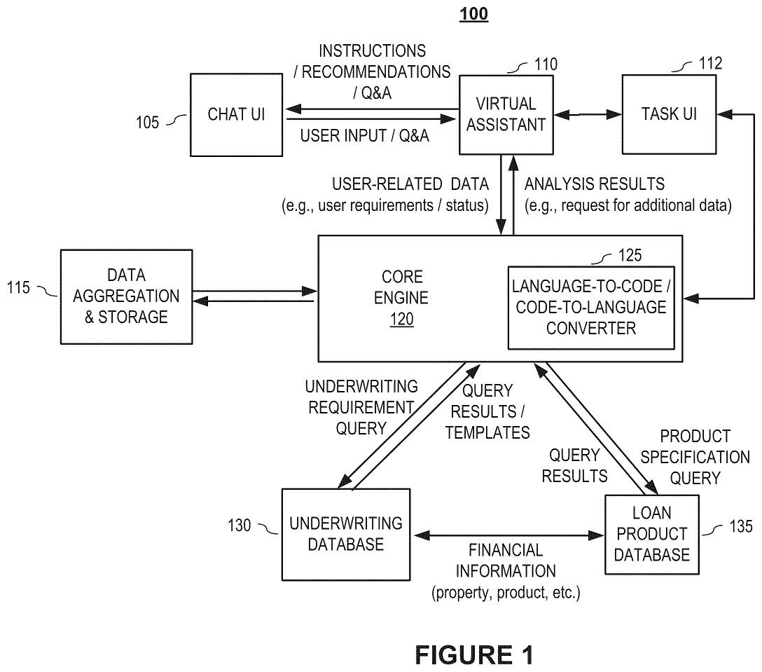

FIG. 1 is a general illustration of a context-aware loan origination system according to various embodiments of the present disclosure. System 100 comprises chat UI 105, virtual assistant 110, task UI 112, and core engine 120, which may comprise converter 125. System 100 may further comprise data aggregation and storage 115, underwriting database 130, and loan product database 135. It is noted that system 100 in FIG. 1 is not limited to the constructional detail shown therein or described in the text below. For example, system 100 may implement other information handling mechanisms not expressly discussed herein.

In operation, core engine 120 may integrate a spectrum of inputs, such as user-related data comprising historical user conversations (e.g., past questions and answers, financial documents, etc.) and pertinent status information (e.g., status of a loan application, financial profiles, target timelines, etc.) as context information to cause virtual assistant 110 to generate tailored questions and/or recommendations, provide comprehensive explanations to user questions, flag potential issues (e.g., missing documents), and discern appropriate actions that should be taken. In this manner, they collaboratively construct a user experience that is informative, responsive, and strategically aligned with the user's unique circumstances and objectives.

In embodiments, core engine 120 may comprise a dedicated rules and decision engine (not shown in FIG. 1) that may access external databases, such as underwriting database 130 and loan product database 135, which may define product specifications and requirements and also process and store such information. In embodiments, core engine 120 may use a language model to analyze content provided by virtual assistant 110, such as a user's financial profile, by applying rules, e.g., to generate user-specific recommendations or some other action based on the results of these rules. Additionally, core engine 120 may further process contents of conversations provided by virtual assistant 110 to make predictions that anticipate questions a particular user may pose and/or answers thereto, e.g., to provide user-specific education or to steer the dialogue in a direction that aligns more effectively with the user's goals.

It is understood that any content generated within system 100 may be fed back in pre-defined or random time-driven or event-driven intervals, to any of the components, e.g., to improve their performance and, by extension, that of the overall system. Some or all steps involving user input, such as uploading documents and answering questions, may occur using chat window 105 that may be conveniently displayed, e.g., on diverse user devices, such as smartphones.

In embodiments, virtual assistant 110 may use core engine 120 to establish direct or indirect connections with one or more lenders, e.g., to retrieve loan product information. Core engine 120 may store and analyze user-specific information and product-related information, e.g., by integrating mathematical models, rule-based decision-making logic, rules engine, etc., and feed the results back to virtual assistant 110. Moreover, data associated with a wide range of users may be used to update or train a language model over time, e.g., to increase the accuracy of subsequent answers generated in interactions with previously unknown users to improve decision-making and overall user experience. It is understood that any model herein may be trained with default rules and/or actions. As discussed in greater detail below, the iterative process allows a model using the knowledge base to generate more relevant answers and better align such answers with the characteristics of a particular user, e.g., to identify several loan products that are best suited for that user.

In embodiments, as discussed in greater detail below, core engine 120 may pinpoint disparities between a user's stated objectives and an available or targeted loan product. This identification of gaps may cause virtual assistant 110 to generate, e.g., one or more questions or tasks that are intended to resolve the discrepancies. Closing such gaps or eliminating existing discrepancies may involve core engine 120 causing virtual assistant 110 to iteratively solicit a user to provide supplementary data, update information relevant to the chat history, perform certain actions as instructed by the virtual assistant 110, and the like. By initiating these types of interactions, virtual assistant 110 may further prompt the user to provide more flexible timelines or uncover additional financial resources or information, such as supporting documents, e.g., to create circumstances that ease actual or perceived limitations that would otherwise present obstacles that stand in the way of securing a preferred achievable solution, such as a particularly favorable loan product for which the user may qualify based on a slightly modified borrower profile.

Advantageously, this may be achieved without subjecting the user to time-consuming efforts that typically involve interactions with a number of loan officers in the pursuit of finding the most suitable available loan product without any guarantees of success. It is understood that changes to the borrower's profile may iteratively trigger reevaluations of available loan products to match the user's specific profile with one or more specific loan products.

In embodiments, core engine 120 may interface with and access underwriting database 130, which may comprise an expansive repository of information pertinent to prospective properties that the borrower is considering purchasing, such as property tax and valuation information, which may have been drawn from external sources, such as public or private databases. In embodiments, loan product database 135 may comprise information about any number of financial products that are available on the market at any moment in time. In embodiments, core engine 120 may treat the functions of a loan officer and an underwriter as a single entity that interacts with the user to ask pointed questions and solicit specific answers and actions, such that the interaction and process driven by the combination of core engine 120 and virtual assistant 110 simulates the loan application itself.

It is understood that, in embodiments, core engine 120 may perform pre-processing steps on received user-related data, such as applying a set of rules to filter the data such as to condense the data to be processed in subsequent calculations. It is further understood that any data security measures known in the art, such as secure channels, encrypted storage, and the like may be advantageously implemented into system 100, without departing from the scope of the present disclosure.

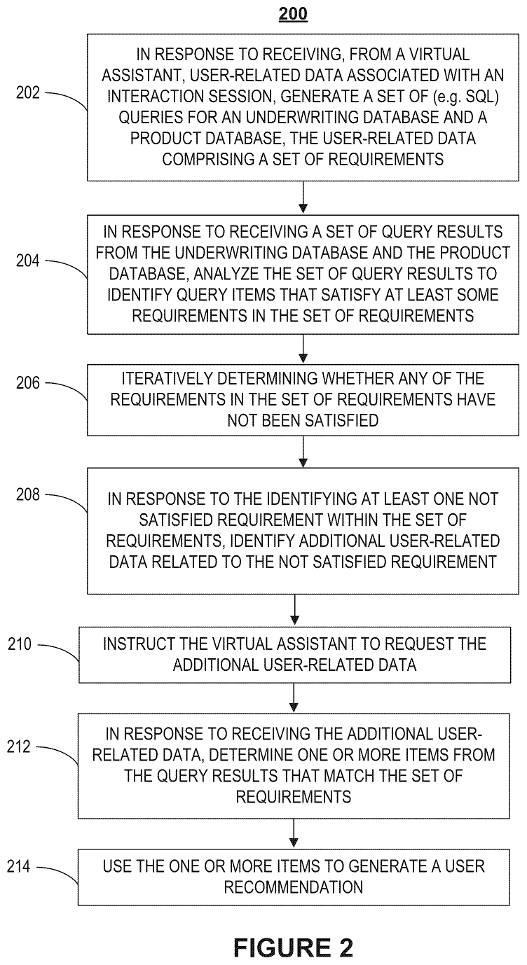

FIG. 2 is a flowchart of an illustrative process for using a context-aware loan origination system shown in FIG. 1 according to various embodiments of the present disclosure. In embodiments, process 200 may start at step 202 when, in response to receiving, from a chat assistant, user-related data that may comprise an array of requirements and is associated with an interaction session, a set of queries (e.g., SQL queries) for an underwriting database and/or a product database is generated.

At step 204, in response to receiving a set of query results from the underwriting database and the product database, the set of query results may be evaluated or analyzed to identify query items that satisfy at least some of the stipulated requirements. At step 206, it may be determined, e.g., in an iterative process, whether any of the requirements in the set of requirements have not been satisfied. At step 208, in response to identifying at least one requirement within the set of requirements that have not been satisfied, additional user-related data related to the unsatisfied requirement may be identified. At step 210, the chat assistant may be instructed to request supplementary user-related data. At step 212, in response to receiving the additional user-related data, one or more items may be determined from the query results that match the set of requirements. Finally, at step 214, one or more items may be used to generate a user recommendation.

One skilled in the art shall recognize that: (1) certain steps may optionally be performed; (2) steps may not be limited to the specific order set forth herein; (3) certain steps may be performed in different orders; and (4) certain steps may be done concurrently.

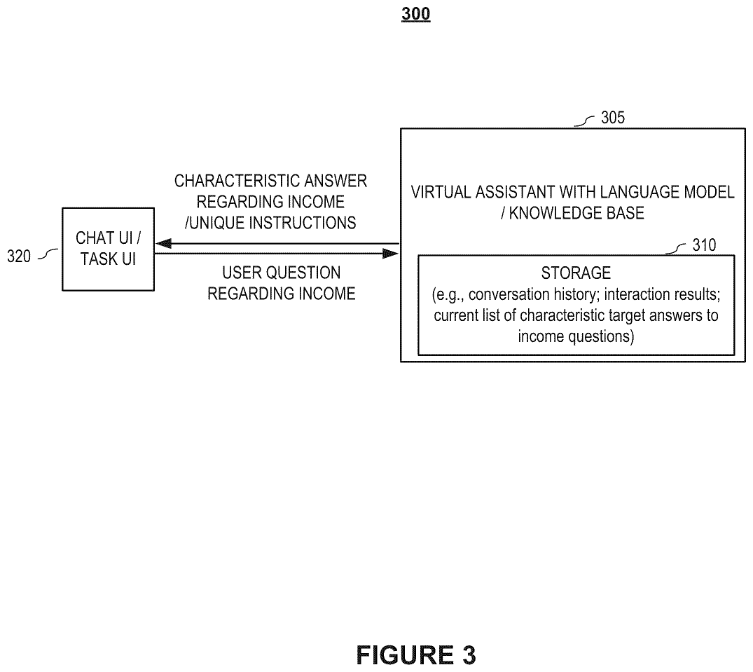

FIG. 3 illustrates a virtual assistant that increases the accuracy of answers, according to various embodiments of the present disclosure. As depicted, virtual assistant 305 may comprise storage 310, e.g., for storing aspects of an interaction at chat UI/task UI 320, such as a conversation history, results of an interaction, or a list of characteristic target answers to income questions. In embodiments, virtual assistant 305 may, e.g., in response to receiving, from chat/task interface 320, a user question regarding income (e.g., a qualified income), use a language model and/or knowledge base to identify a characteristic answer associated with the question. The virtual assistant may generate a set of unique instructions associated with the characteristic answer and populate chat/task interface 320 with such answers, e.g., before processing with a subsequent question. In embodiments, virtual assistant 305 may assign and/or weigh one or more parameters to each question or request to generate more relevant answers.

In embodiments, in response to receiving a subsequent related user question, virtual assistant 305 may identify a subsequent characteristic answer from a set of characteristic answers that more closely matches the related question posed by a user. To increase accuracy, the virtual assistant may then generate a set of unique instructions associated with the subsequent characteristic answer.

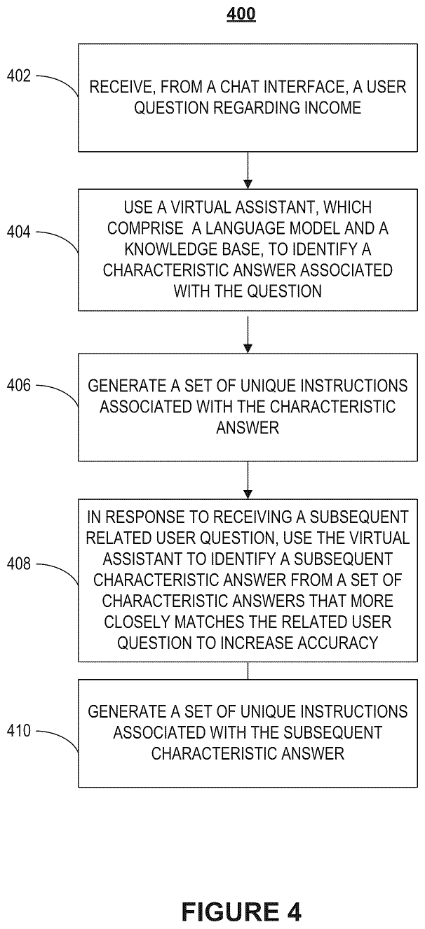

FIG. 4 is a flowchart of an illustrative process for increasing the accuracy of answers, according to various embodiments of the present disclosure. Process 400 may start at step 402 when a virtual assistant receives, from a chat interface or task interface, a user question regarding income. At step 404, the virtual assistant, which may comprise or access a language model and a knowledge base, identifies a characteristic answer associated with the question. At step 406, the virtual assistant may generate a set of unique instructions associated with the characteristic answer. At step 408, in response to receiving a subsequent related user question, the virtual assistant may identify a subsequent characteristic answer from a set of characteristic answers that more closely matches the related user question to increase accuracy. Finally, at step 410, the virtual assistant may generate a set of unique instructions associated with the subsequent characteristic answer.

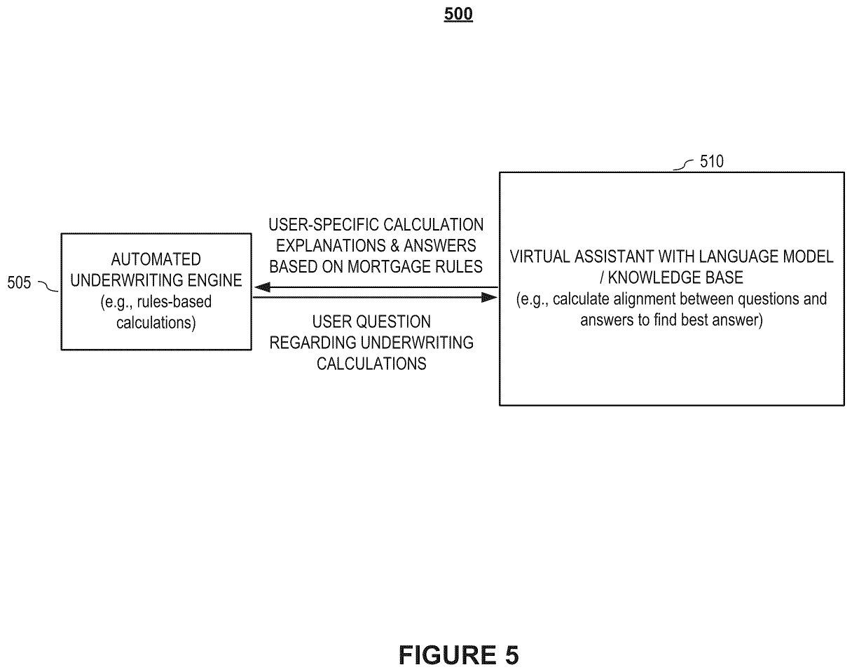

FIG. 5 illustrates a virtual assistant that aligns or calibrates questions and answers to generate explanatory text regarding calculations, according to various embodiments of the present disclosure. In embodiments, virtual assistant 510, which may comprise a language model and/or knowledge base, may receive from the automated underwriting engine 505 a user question regarding an underwriting calculation. In response to receiving the question(s), virtual assistant 510 may calculate an alignment between the user question and answers in the knowledge base to identify an answer to the question to explain the underwriting calculation. For example, fully automated underwriting engine 505 may be used to explain a qualified income calculation to a user. To accomplish this, the output of underwriting engine 505, e.g., mortgage rules and formulas from a knowledge database, may be integrated with conversations related to such income calculations to find the most suitable answer to the question that allows the user to properly understand the income calculation. In embodiments, such integration may comprise recalculations of an alignment between the output of the underwriting engine and the conversations.

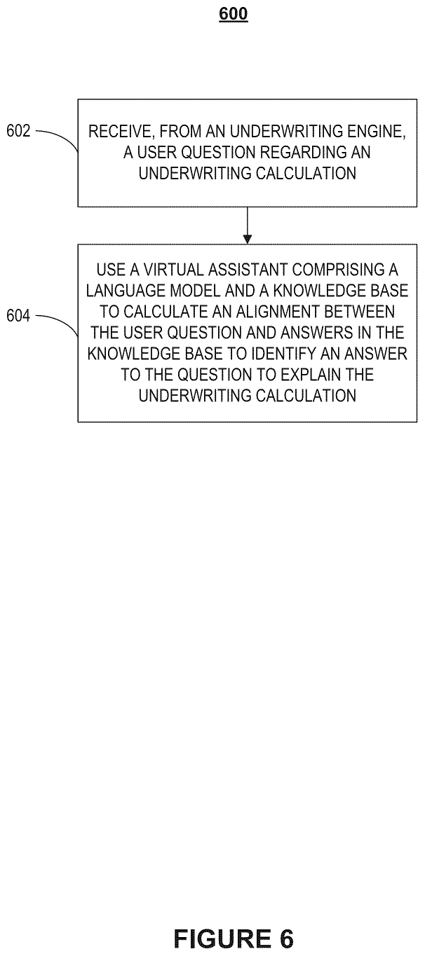

It is noted that embodiments described herein are discussed in the context of a large language model. However, a person of skill in the art will appreciate that no specific language model is necessary to achieve the objectives of the present disclosure. It is further noted that calculations may be adjusted in real-time, e.g., any time a user provides updated or additional information, calculations may be rerun to determine loan products affected by such information, e.g., to identify loan products that were not available to the user based on previously provided information. The resulting changes may be highlighted for the user to see at a user interface (not shown in FIG. 6).

FIG. 6 is a flowchart of an illustrative process for explaining a calculation, according to various embodiments of the present disclosure. Process 600 may start at step 602 when, e.g., a virtual assistant receives, from an underwriting engine, a user question regarding an underwriting calculation. At step 604, the virtual assistant may calculate an alignment between the user question and answers in the knowledge base to identify an answer to the question to explain the underwriting calculation. Oftentimes, a user may be uncertain about what kind of questions to ask or may need guidance to meet certain loan requirements to match one or more suitable target loan products for that particular user. Conversely, a user may be identified as a target customer for one or more loan products, e.g., a minority business loan product.

In embodiments, to increase a potential match between users and products, for example, when the user's qualified income is slightly below a target loan amount, this information may serve as context to generate one or more questions or suggestions, such as an inquiry into tip income for a service worker that was previously not disclosed by the user. Similarly, a suggestion to pay off a certain credit card debt may enable a user to reach a target loan, in effect, by modifying the qualified income amount to meet a lender's loan requirements. In this manner, any number of user data may serve as context to tailor a series of questions, e.g., according to a user profile, to interact with a particular user. It is understood that questions and answers may be presented in the context of a problem that is to be solved.

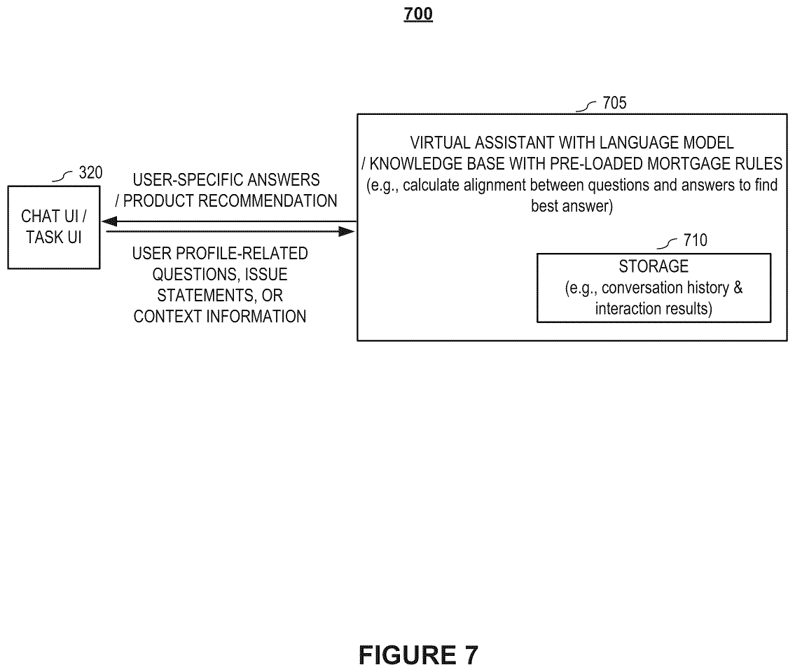

FIG. 7 illustrates a virtual assistant that aligns or calibrates questions and answers to generate user-specific answers and/or product recommendations based on interactions at a chat interface or task interface, according to various embodiments of the present disclosure. As depicted, virtual assistant 705 may comprise a language model or a knowledge base that, in turn, may comprise a set of pre-loaded mortgage rules. In addition, virtual assistant 705 may record any type of user input data and store any aspects of the interaction at chat UI/task UI 320, such as a conversation history or the results of an interaction, in storage 710.

In embodiments, virtual assistant 705 may, in response to receiving user profile-related questions, issue statements, and/or context information, generate a user-specific answer and/or a product recommendation by analyzing or evaluating the received data using the language model or the knowledge base. In embodiments, virtual assistant 705 may use received and/or generated answers, e.g., based on an evaluation of the pre-loaded mortgage rules, to identify a user as a potential target customer for a specific loan product.

It is understood that, in embodiments, virtual assistant 705 may iteratively generate and adjust questions and/or suggestions, e.g., until a match between a user's objectives and an available product is achieved. It is further understood that a user may interact with chat UI/task UI 320 using any data input method known in the art, such as speech recognition, etc.

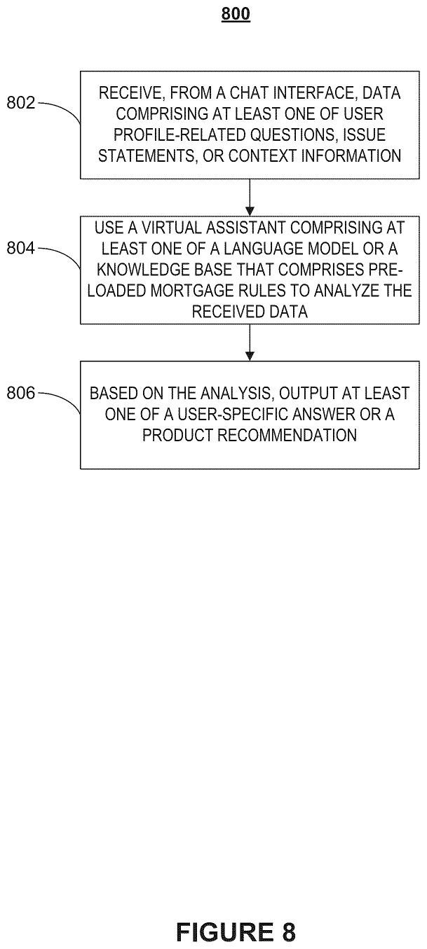

FIG. 8 is a flowchart of an illustrative process for generating user-specific answers and/or product recommendations based on interactions at a chat interface or task interface, according to various embodiments of the present disclosure. Process 800 may start at step 802 when a virtual assistant receives, at a chat interface, data that may comprise user profile-related questions, issue statements, or context information. In embodiments, the virtual assistant may comprise a language model or a knowledge base that, as shown in FIG. 7, may comprise and enforce a set of pre-loaded mortgage rules.

Finally, at step 804, the virtual assistant may use the language model/knowledge base to analyze the received data and, based on the analysis result, the virtual assistant may, at step 806, generate a user-specific answer and/or a product recommendation.

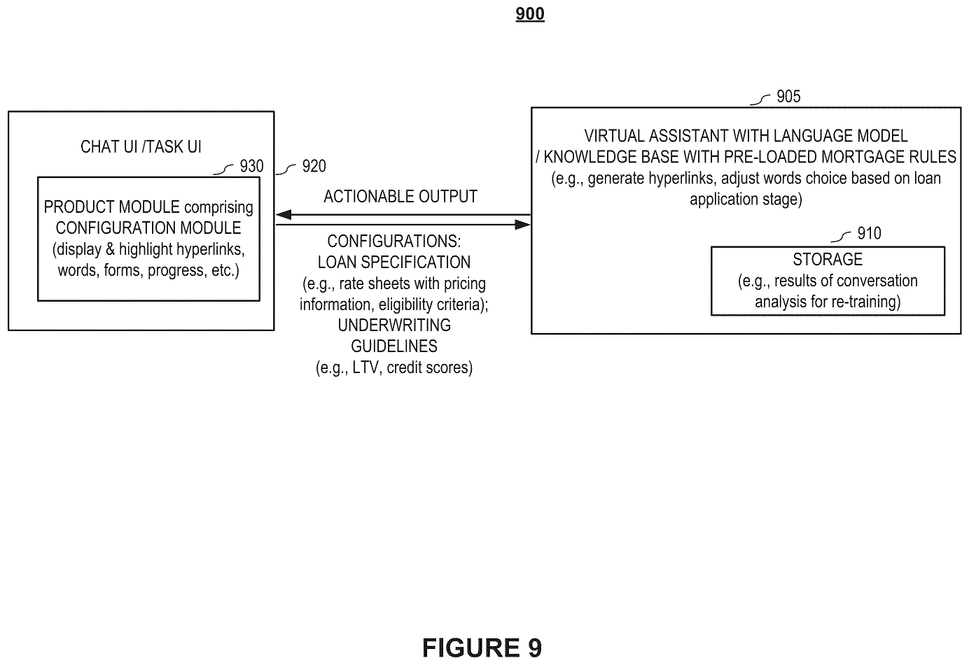

FIG. 9 illustrates a virtual assistant that generates actionable outputs based on configurable loan specification, according to various embodiments of the present disclosure. Virtual assistant in FIG. 9, in embodiments, may select or adjust word choice based on a user's progress within an application process. For example, virtual assistant 905 may take into account the stage at which a borrower is in application process at any given moment to adjust the word choice in a conversation in a manner that drives the loan application process forward and generates actionable outputs, such as recommendations for next steps, etc. To accomplish this, virtual assistant 905 may customize the conversion to generate hyperlinks that are displayed on chat UI 920. For example, once a borrower starts filling out a loan application, virtual assistant 905 may dynamically create one or more links, e.g., links that provide the borrower with product pricing information. Such links may direct the borrower's attention to information that aids the borrower in correcting or updating parameters in the loan application to obtain more accurate pricing information.

In embodiments, chat UI/task UI 920 may comprise configurable product module 930 that “investor” users may use to provide loan specifications for their products in form of, e.g., investor rate sheets, pricing information, eligibility criteria, etc.) based on various factors, that may be customized and tailored to specific circumstances. An investor user may use configuration module 930 to communicate underwriting guidelines that may specify requirements for any combination of, e.g., loan-to-value ratio, credit scores, and the like. The investor and/or administrator may modify, configuration parameter for loan specifications and underwriting guidelines, for example, by imposing additional loan criteria to lower risk to the inventor. Product module 930 may present the details of the finalized loan specifications and underwriting guidelines to the borrower on chat UI/task UI 920.

In embodiments, the model on which virtual assistant 905 operates may be trained with mortgage-specific information, such that it can answer mortgage-specific questions when conversing with borrowers and create a conversation that comprises actionable outputs. For example, to advance the loan application process, virtual assistant 905 may generate user-specific instructions to guide the user to answer questions or take one or more steps in furtherance of the application process. Such instructions may also be provided in the form of virtual assistant-created links displayed in chat UI/task UI 920 to further assist the borrower. As an example, virtual assistant 905 may generate a link to a form that would be required by an underwriter based on the specific situation of the borrower. If the form requires a permission, e.g., to access a credit report, the virtual assistant may steer the conversation and ask for permission to obtain and analyze the report and, if necessary, answer any question or direct the borrower's attention to items that need further explanation, and process the borrower's response accordingly, e.g., by analyzing supporting documentation that the borrower may upload. Furthermore, in embodiments, virtual assistant 905 may highlight portions of chat UI/task UI 920 to indicate the borrower's progress such as to aid borrowers in orienting themselves in the process.

Virtual assistant 905 may analyze conversations to determine where, when, and why a customer requires assistance indicative of a problem or a difficulty in understanding. In embodiments, the results of such analysis may be then used to update or re-train the model of virtual assistant 905, e.g., from time to time, to provide relevant answers in subsequent interactions with users and improve overall user experience.

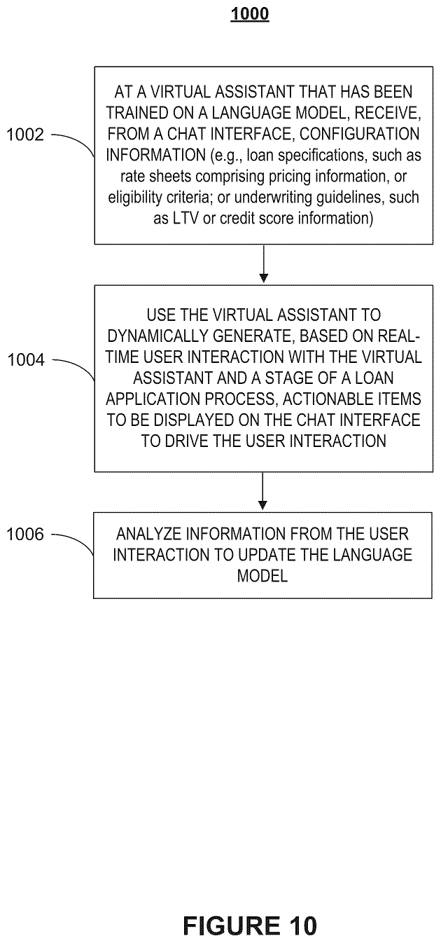

FIG. 10 is a flowchart of an illustrative process for actionable outputs based on configurable loan specification, according to various embodiments of the present disclosure. Process 1000 may start at step 1002 when a virtual assistant that has been trained on a language model, receives, from a chat interface, configuration information, such as loan specifications (e.g., rate sheets comprising pricing information, or eligibility criteria) or underwriting guidelines (e.g., LTV or credit score information).

At step 1004, the virtual assistant may be used to dynamically generate, e.g., based on real-time user interaction with the virtual assistant and the stage of a loan application process, actionable items that are to be displayed on the chat interface to advance the conversation toward the user's goals. At step 1006, in embodiments, information from the user interaction may be used to update the language model. It is noted that any process steps mentioned in this patent document may be optional and need not be performed in a specific order. Further, certain steps may be performed concurrently.

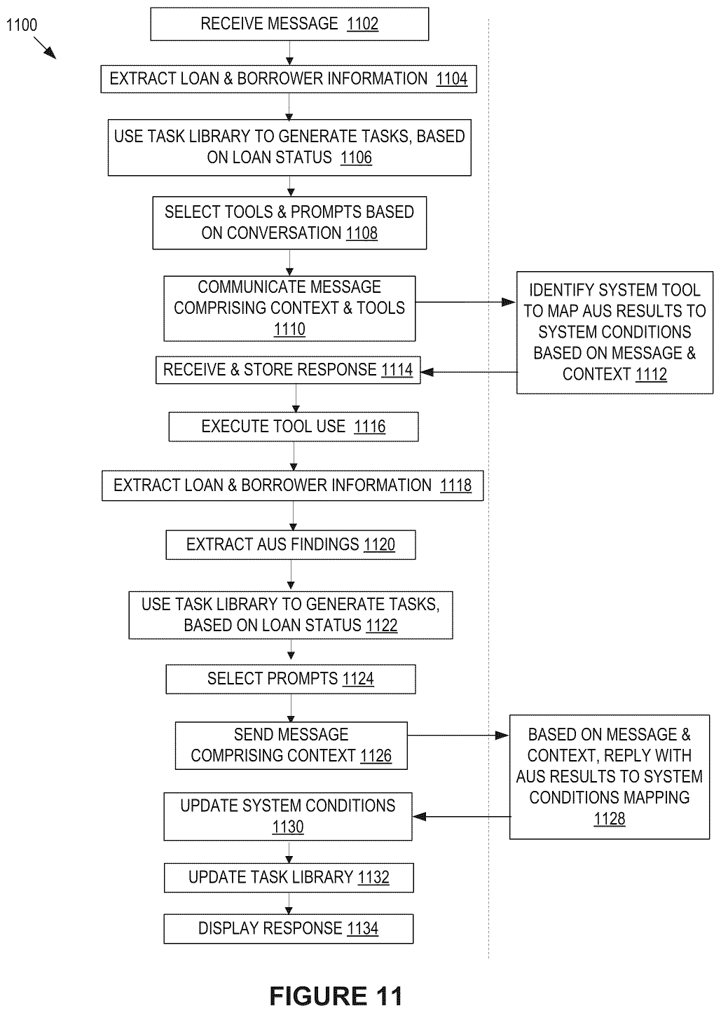

To further enhance the capabilities of the loan origination system, FIG. 11 illustrates integration of an Automated Underwriting System (AUS) with the virtual assistant and task management components. The integration comprises processes managed by a chat manager that interacts with a generative AI system to ensure that each step of the loan application is tailored to borrowers' unique situations.

FIG. 11 is a flowchart illustrating a process for using an AUS, according to various embodiments of the present disclosure. Process 1100 enhances the efficiency and accuracy of the loan origination process by leveraging a chat manager in conjunction with a generative AI system. In embodiments, process 1100 may begin at step 1102, when a chat manager receives a message from a conversation with a user. This triggers the extraction of information such as borrower details or loan conditions, at step 1104, by the chat manager.

At step 1106, the chat manager uses a task library to generate tasks based on a loan's current status, e.g., to remain aligned with the user's progress in the loan application process.

At step 1108, based on the conversation that serves as context, the chat manager selects tools and/or prompts that may be used to guide the user further through the loan process.

At step 1110, the chat manager communicates with a generative artificial intelligence (AI) system a message by sending a message that comprises context information and a set of tools that may have been selected.

In response to the generative AI system, at step 1112, analyzing the data and identifying and communicating to the chat manager a response that may comprise a system tool designed to map Automated Underwriting System (AUS) results to system conditions, e.g., based on the message and the context, the chat manager, at step 1114, receives and stores the response.

At step 1116, the chat manager executes the tool to extract, at step 1118, detailed loan information and borrower information and extract, at step 1120, the AUS findings.

At step 1122, the chat manager uses a task library to generate further tasks based on the loan status.

At step 1124, the chat manager selects new prompts to sends to the generative AI system. In embodiments, this iterative communication process ensures that the system continually adapts to the latest borrower data.

At step 1126, the chat manager sends an appropriate message to the generative AI system, which responds, at step 1128, with updated AUS results, which the chat manager uses to update the system conditions, at step 1130, and update the task library, at step 1132.

Finally, at step 1134, the chat manager causes a response to be displayed to the user that is intended to guide the next steps of the user in the loan application process.

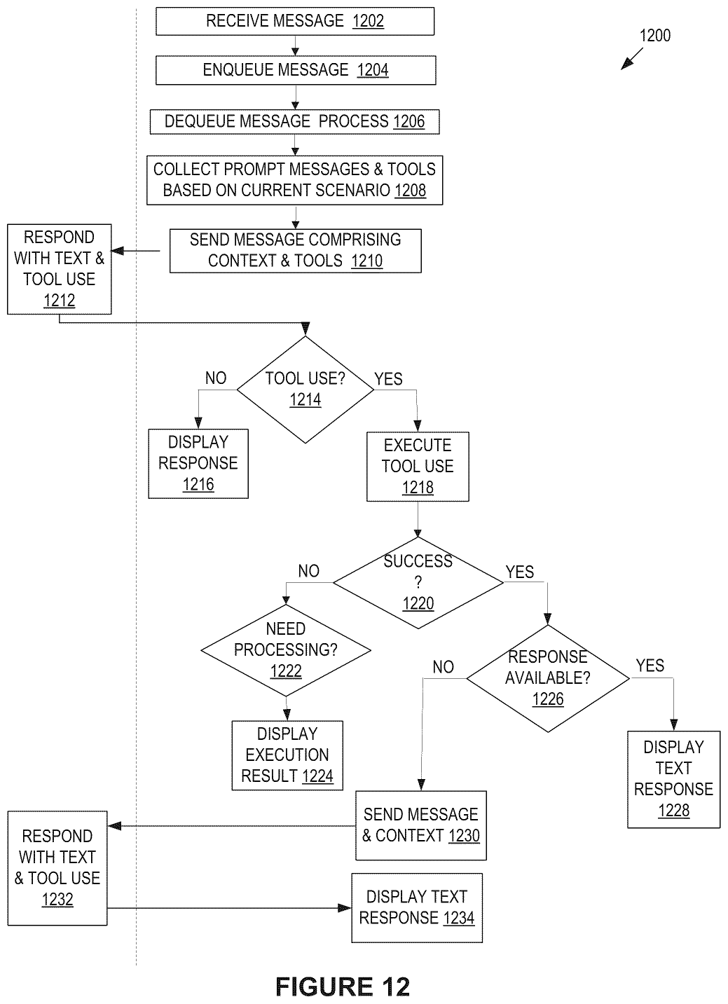

In embodiments, by leveraging the chat manager's ability to interact with a generative AI system, the loan origination process is made highly dynamic. The task library ensures that the correct actions are taken at every stage, while the AUS provides crucial data that informs the system's decisions. This synergy, as detailed in process 1200 in FIG. 12, enables the advantageous integration of AI-driven decision-making with traditional loan processing tasks.

In short, the integration of the AUS with the chat manager and generative AI system significantly improves the loan origination process. By automating complex tasks and ensuring real-time responsiveness to user inputs, the system not only reduces processing time but also enhances accuracy and transparency. These improvements enhance the overall goal of making the loan process more accessible and less burdensome for borrowers, while also providing lenders with a more efficient and reliably repeatable process.

FIG. 12 is a flowchart illustrating a process for managing user interactions and tool execution, according to various embodiments of the present disclosure. In embodiments, process 1200 may begin at step 1202, when a chat manager receives a message from a conversation with a user.

At step 1204, the chat manager enqueues the message and, at step 1206, dequeues the message for processing, e.g., to ensure that messages are handled in an appropriate order.

At step 1208, based on a current scenario and the context provided by the conversation, the chat manager selects prompt messages and a set of tools tailored to specific needs of the user at that stage in the loan application process.

At step 1210, the chat manager communicates the selected context information and the tools as input to a generative AI system.

At step 1212, the generative AI system analyzes the input and responds with text instructions and guidance of how to use the tools.

At step 1214, the chat manager determines whether tool use suggested by generative AI system is appropriate. If a tool is deemed unnecessary, process 1200 ends by displaying the AI-generated text to the user.

Otherwise, at step 1218, the chat manager executes the tool and determines, at step 1220 whether the execution was successful, e.g., to determine next steps. If tool execution is deemed successful, process 1200 determines whether further processing is required and, if so, process 1200 resumes with step 1204. Otherwise, if no further processing is required, the chat manager displays, at step 1224, the result of the tool execution together with ant relevant text responses.

If at step 1220, if is determined that tool execution was not successful, process 1200 continues with step 1226 where the chat manager determines whether an alternative text response is available.

If so, this response is displayed to the user. Otherwise, if no alternative text response is available, the chat manager communicates, at step 1230, a new context message to the generative AI system to obtain further instructions, at step 1232, which the chat manager then displays to the user, at step 1234.

In embodiments, the results of process 1200 may be integrated into the broader system, updating conditions and task libraries as needed, and guiding users through next steps in their loan origination process.

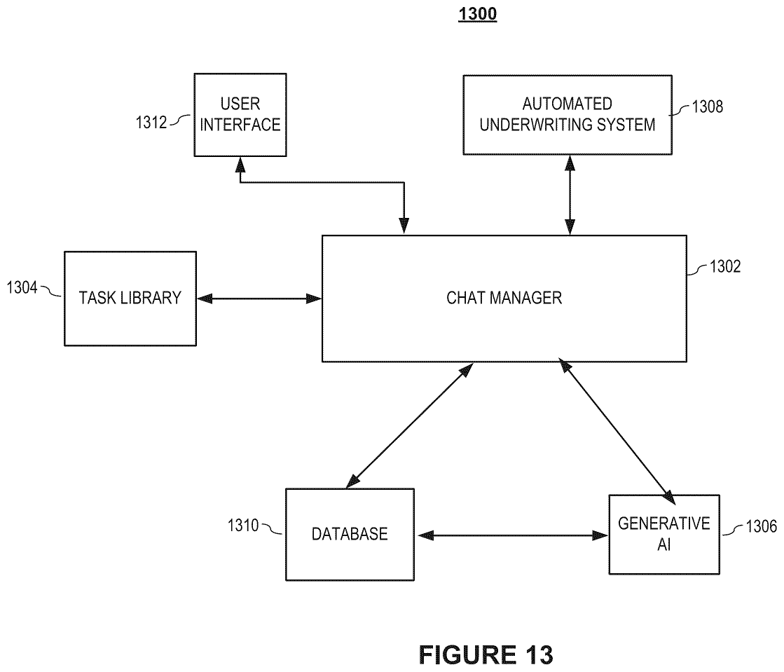

FIG. 13 illustrates a system for performing the processes in FIG. 11 and/or FIG. 12 to manage a loan origination process, according to various embodiments of the present disclosure. System 1300 comprises chat manager 1302, task library 1304, generative AI system 1306, automated AUS 1308, database 1310, and user interface (UI) 1312. As depicted in FIG. 13, task library 1304, generative AI system 1306, AUS 1308, and database 1310, and UI 1312 may be communicatively coupled to chat manager 1302. In addition, database 1310 may be coupled to generative AI system 1306.

In operation, chat manager 1302 receives user messages via UI 1312 and processes these messages by determining the context and extracting relevant loan or borrower information. Once the context is established, chat manager 1302 interacts with task library 1304 to retrieve predefined tasks appropriate for a current stage of the loan application process. Such tasks may comprise actions such as requesting additional information, verifying documents, or calculating loan eligibility.

Chat manager 1302 may communicate the selected tasks, along with context information, to generative AI system 1306. In embodiments, generative AI system 1306 analyzes the input to generate context-aware recommendations, instructions, and decisions. Its output is sent to chat manager 1302, which uses that output to determine whether to execute specific tools or proceed with other actions.

If tool execution is required, chat manager 1302 sends borrower data and loan-related information to AUS 1308. AUS 1308 evaluates the data to assess loan eligibility, considering various factors such as credit scores, income, and liabilities. The findings from AUS 1308 are returned to chat manager 1302, informing the next steps in the loan application process.

Throughout the operation, database 1310 receives and stores relevant data, including user interaction history, financial documents, borrower profiles, and AUS findings. As a centralized data repository, database 1310 ensures that chat manager 1302 and generative AI system 1306 have access to the most current and accurate information to guide users in their decision-making.

Finally, chat manager 1302 outputs the results of the process to UI 1312, where they are displayed to the user. Exemplary outputs comprise recommendations, instructions, or updates on the loan application status, allowing users to interact with system 1300, provide further inputs, and make informed decisions based on the guidance provided. The iterative nature of the interactions allow system 1300 to continuously refine its operations to provide a dynamic and user-centered loan origination experience.

In embodiments, aspects of the present patent document may be directed to, may include, or may be implemented on one or more information handling systems/computing systems. A computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, phablet, personal digital assistant (PDA), smartphone, smart watch, smart package, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, ROM, and/or other types of memory. Additional components of the computing system may include one or more disk drives, one or more network ports for communicating with external devices as well as various input and output (I/O) devices, such as a keyboard, a mouse, a touchscreen, and/or a video display. The computing system may also include one or more buses operable to transmit communications between the various hardware components.

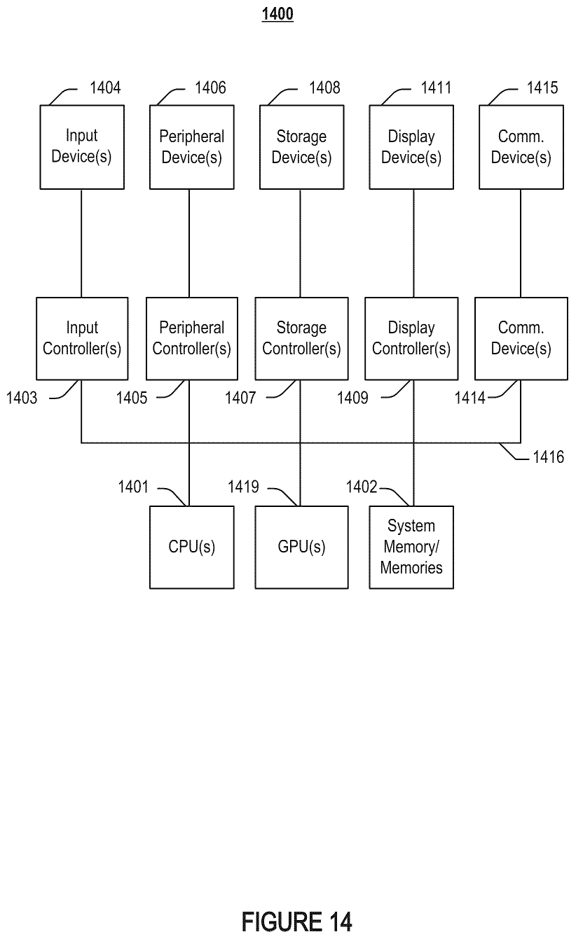

FIG. 14 depicts a simplified block diagram of a computing device/information handling system (or computing system) according to embodiments of the present disclosure. It will be understood that the functionalities shown for system 1400 may operate to support various embodiments of a computing system-although it shall be understood that a computing system may be differently configured and include different components, including having fewer or more components as depicted in FIG. 14.

As illustrated in FIG. 14, the computing system 1400 includes one or more central processing units (CPU) 1401 that provide computing resources and control the computer. CPU 1401 may be implemented with a microprocessor or the like, and may also include one or more graphics processing units (GPU) 1419 and/or a floating-point coprocessor for mathematical computations. System 1400 may also include a system memory 1402, which may be in the form of random-access memory (RAM), read-only memory (ROM), or both.

A number of controllers and peripheral devices may also be provided, as shown in FIG. 14. An input controller 1403 represents an interface to various input device(s) 1404, such as a keyboard, mouse, touchscreen, and/or stylus. The computing system 1400 may also include a storage controller 1407 for interfacing with one or more storage devices 1408 each of which includes a storage medium such as magnetic tape or disk, or an optical medium that might be used to record programs of instructions for operating systems, utilities, and applications, which may include embodiments of programs that implement various aspects of the present invention. Storage device(s) 1408 may also be used to store processed data or data to be processed in accordance with the invention. The system 1400 may also include a display controller 1409 for providing an interface to a display device 1411, which may be a cathode ray tube (CRT), a thin film transistor (TFT) display, organic light-emitting diode, electroluminescent panel, plasma panel, or other type of display. The computing system 1400 may also include one or more peripheral controllers or interfaces 1405 for one or more peripherals 1406. Examples of peripherals may include one or more printers, scanners, input devices, output devices, sensors, and the like. A communications controller 1414 may interface with one or more communication devices 1415, which enables the system 1400 to connect to remote devices through any of a variety of networks including the Internet, a cloud resource (e.g., an Ethernet cloud, a Fiber Channel over Ethernet (FCOE)/Data Center Bridging (DCB) cloud, etc.), a local area network (LAN), a wide area network (WAN), a storage area network (SAN) or through any suitable electromagnetic carrier signals including infrared signals.

In the illustrated system, all major system components may connect to a bus 1416, which may represent more than one physical bus. However, various system components may or may not be in physical proximity to one another. For example, input data and/or output data may be remotely transmitted from one physical location to another. In addition, programs that implement various aspects of the invention may be accessed from a remote location (e.g., a server) over a network. Such data and/or programs may be conveyed through any of a variety of machine-readable mediums including, but not limited to magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Aspects of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher-level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in local, remote, or both settings.

A person skilled in the art will recognize no computing system or programming language is critical to the practice of the present disclosure. Such person will also recognize that a number of the elements described above may be physically and/or functionally separated into modules and/or sub-modules or combined.

It will be appreciated by those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A method for managing a loan origination process, the method comprising:
by a chat manager, in response to receiving a message from a user conversation, extracting borrower details and loan conditions;
using a task library to generate tasks based on a current loan status;
selecting a set of tools and prompts based on a context of the user conversation to guide the user through a loan process;
communicating context information and the set of tools to a generative artificial intelligence (AI) system;
receiving and storing a response from the generative AI system, the response comprising system tools and instructions;
executing the system tools to extract loan information and borrower data, and mapping Automated Underwriting System (AUS) results to system conditions;
iteratively updating system conditions and the task library based on updates generated by the generative AI system; and
displaying a system-generated response to the user that directs subsequent steps in the loan process.

2. The method of claim 1, further comprising, in response to determining that an execution of the system tools fails, sending updated context information to the generative AI system to obtain further instructions.

3. The method of claim 2, wherein the chat manager, in response to determining that a text response is available when the execution of the system tool fails, displays the text response to the user.

4. The method of claim 1, wherein the task library comprises one or more predefined tasks that each correspond to one or more stages in the loan process.

5. The method of claim 1, wherein the generative AI system analyzes context information to generate one or more instructions for using the system tools.

6. The method of claim 1, wherein the chat manager enqueues and dequeues user messages to maintain a proper processing order.

7. The method of claim 1, wherein the chat manager, after each execution of the system tools, determines whether further processing is required, and if so, re-evaluates the current loan status and updates the task library.

8. The method of claim 1, wherein the generative AI system provides text instructions and guidance for use of the system tools based on a current scenario and a current user context.

9. The method of claim 1, wherein the chat manager iteratively communicates updated system conditions and context information to the generative AI system to enable the system to adapt to updated borrower data.

10. The method of claim 1, wherein the task library updates and generates new tasks based on results and findings provided by the AUS.

11. A system for managing a loan origination process, the system comprising:
a chat manager configured to receive messages from a user via a user interface (UI) and process the messages to extract borrower details and loan conditions;
a task library communicatively coupled to the chat manager, the task library configured to generate tasks based on a current loan status;
a generative AI system communicatively coupled to the chat manager, the generative AI system configured to analyze context information and provide one or more instructions and guidance for using system tools;
an automated underwriting system (AUS) communicatively coupled to the chat manager, the AUS configured to evaluate borrower data and loan-related information to assess loan eligibility;
a database communicatively coupled to the chat manager, the database configured to store relevant data including user interaction history, borrower profiles, financial documents, and AUS findings;
a user interface (UI) communicatively coupled to the chat manager, the UI configured to display results, recommendations, instructions, and updates to the user.

12. The system of claim 11, wherein the chat manager is further configured to enqueue and dequeue the messages to ensure proper processing order.

13. The system of claim 11, wherein the task library comprises one or more tasks that each correspond to one or more stages in the loan process.

14. The system of claim 11, wherein the generative AI system iteratively communicates with the chat manager to adapt to updated borrower data.

15. The system of claim 11, wherein the chat manager, after each execution of the system tools, determines whether further processing is required, and if so, re-evaluates the loan status and updates the task library.

16. The system of claim 11, wherein the database serves as a centralized data repository that provides the chat manager and the generative AI system access to current and accurate information to guide user decision-making.

17. The system of claim 11, wherein the AUS provides data that informs system decisions to enable an integration of AI-driven decision-making with loan processing tasks.

18. A non-transitory computer-readable medium comprising instructions that, when executed by a processor, cause steps to be performed, the steps comprising:
receiving, from a chat manager, a message from a user conversation, and extracting borrower details and loan conditions;
using a task library to generate tasks based on a current loan status;
selecting tools and prompts based on the conversation context to guide the user through a loan process;
communicating context information and the set of tools to a generative artificial intelligence (AI) system;
receiving and storing a response from the generative AI system, the response comprising system tools and instructions;
executing the system tools to extract loan information and borrower data, and mapping Automated Underwriting System (AUS) results to system conditions;
iteratively updating system conditions and the task library based on updates generated by the generative AI system; and
displaying a system-generated response to the user that directs subsequent steps in the loan process.

19. The non-transitory computer-readable medium of claim 18, further comprising instructions for determining whether the execution of the system tools was successful, and if not, sending updated context information to the generative AI system to obtain further instructions.

20. The non-transitory computer-readable medium of claim 18, further comprising instructions for determining whether further processing is required after each tool execution, and if so, re-evaluating the loan status and updating the task library.
